(19) United States
(12) Patent Application Publication
(10) Pub. No.: US 2006/0042450 A1
(43) Pub. Date: Mar. 2, 2006

(54) Guitar machine head string lock function

(76) Inventor: Ping Chang, Taichung City (TW)

Correspondence Address: BIRCH STEWART KOLASCH & BIRCH, PO BOX 747, FALLS CHURCH, VA, 22040-0747, US

(21) Appl. No.: 10/930,830

(22) Filed: Sep. 1, 2004

(51) Int. Cl. G10D 3/14; G10D 3/04; G10D 1/08

(52) U.S. Cl. 84/312 R

(57) ABSTRACT

A guitar machine head string lock function includes a worm gear, a worm, a string post and a base. The worm gear and the string post are formed in an integrated manner, and are pivotally coupled on the base through a latch element. Assembly is simple and convenient and can achieve precise coupling. The worm is pivotally mounted on the base to engage with the worm gear and has a tuning peg to enable users to turn the worm gear and the string post to adjust the tension of a guitar string.

### FIELD OF THE INVENTION

The present invention relates to guitar structure and particularly to guitar machine head string lock function

### BACKGROUND OF THE INVENTION

Guitar is a string instrument that must have a string lock function to adjust the tension of the strings to achieve precise tone quality. Refer to FIG. 1 for a conventional string lock function. It includes a worm gear 1 and a string post 7 that have respectively a corresponding gear structure 6 and 8 to enable the worm gear 1 and the string post 7 to turn synchronously. The worm gear 1 and the string post 7 are fastened to a base 3 through a screw 5. A worm 2 is pivotally mounted on the base 3 to engage with the worm gear 1 to adjust the tension of the guitar string. As deviation is unavoidable during machining, when the worm gear 1 and the string post 7 are fastened to the base 3, a certain amount of circular coupling deviation occurs between the worm gear 1 and the string post 7. The corresponding engaging gear structure 6 and 8 also have clearance. As a result, it is difficult for users to adjust the string tension steadily. To prevent the worm gear 1 and the string post 7 from being strangled on the base 3, the screw 5 should not fasten the worm gear 1 and the string post 7 too tightly, otherwise the synchronous turning of the worm gear 1 and the string post 7 on the base 3 will be hindered. However, not fastening the screw 5 tightly might result in loosening of the screw 5 and affect the tension stability of the string and impair the tone quality. In short, the conventional techniques do not provide simple assembly. The coupling precision tends to be affected by machining tolerance. The screw 5 is prone to loosening. All this indicates that there is still room for improvement on the guitar machine head string lock function.

### SUMMARY OF THE INVENTION

Therefore the primary object of the present invention is to provide a guitar machine head string lock function that offers precise coupling and easy assembly.

The guitar machine head string lock function according to the invention includes a worm gear, a worm, a string post and a base. The worm gear and the string post are integrally formed. They are pivotally coupled on the base through a latch element. The worm is pivotally mounted onto the base to engage with the worm gear. The worm has a tuning peg which enables users to turn the worm and drive the worm gear and the string post to adjust the tension of a guitar string.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional guitar machine head string lock function.

FIG. 2 is an exploded view of the guitar machine head string lock function of the invention.

FIG. 3A is a schematic view of the guitar machine head string lock function of the present invention after assembled.

FIG. 3B is a cross section taken on line 3B-3B in FIG. 3A.

FIG. 3C is a fragmentary enlarged view of FIG. 3B.

FIG. 4 is a schematic view of an embodiment of the invention.

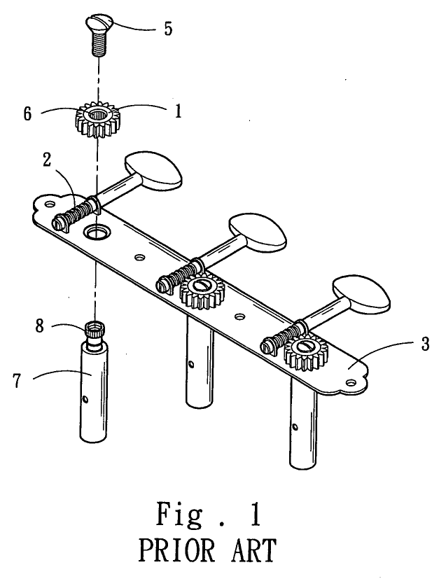

### DETAILED DESCRIPTION OF THE PREFERRED EMBODIMENT

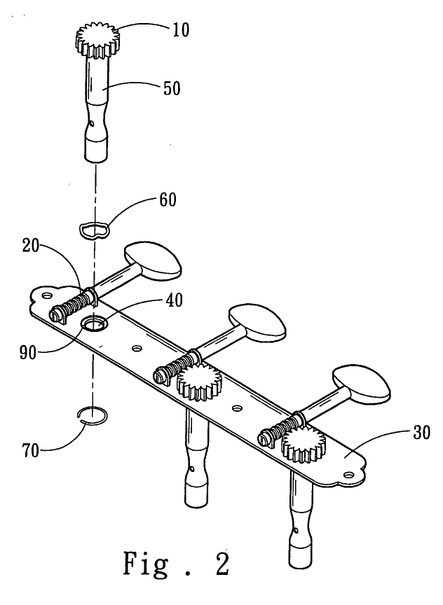

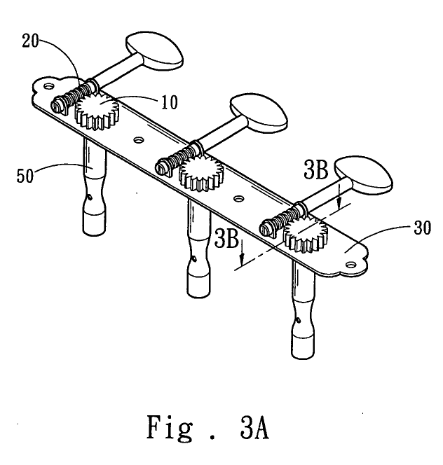

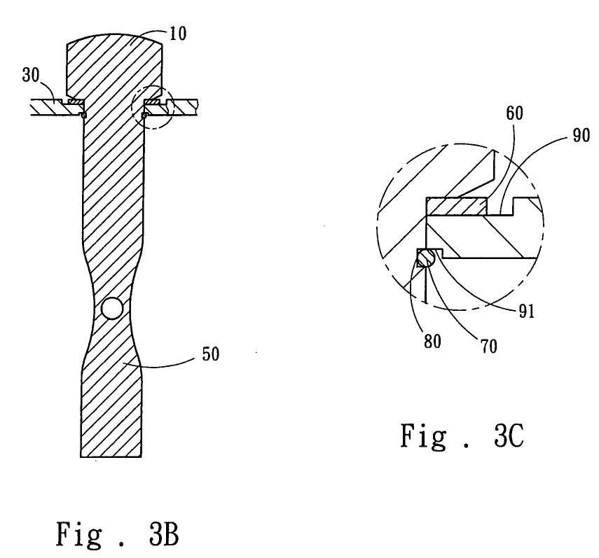

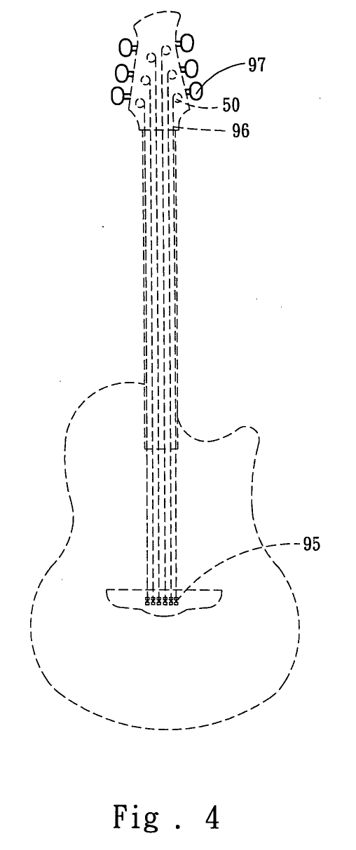

Please referring to FIGS. 2 and 3A, the guitar head string lock function according to the present invention includes a worm gear 10, a worm 20, a string post 50 and a base 30. The base 30 has a bore 40 with a diameter smaller than the worm gear 10 to receive the string post 50 which is integrally formed with the worm gear 10. As the size of the worm gear 10 is larger than the bore 40, the worm gear 10 will be latched on the bore 40 when the integrated worm gear 10 and the string post 50 is coupled in the bore 40. A latch element 70 larger than the bore 40 is provided to couple the string post 50 on an outer side to latch the string post 70 on the base 30 in a pivotal manner. An elastic element 60 with an outer perimeter larger than the bore 40 may also be provided to couple the string post 50 on another side and be interposed between the base 30 and the worm gear 10. The elasticity of the elastic element 60 enables the integrated worm gear 10 and the string post 50 that are pivotally mounted on the base 30 to be turned steadily and smoothly.

Referring to FIGS. 3B and 3C, the integrated worm gear 10 and the string post 50 are pivotally anchored on base 30 by means of the elastic element 60 and the latch element 70. The elastic element 60 may be a undulate spring or an elastic washer aiming to provide a steady pressure to maintain a desired distance between the worm gear 10 and the base 30 so that direct friction may be avoided between the worm gear 10 and the base 30. Thereby turning of the integrated worm gear 10 and the string post 50 may be smoother with less impediment. The latch element 70 may be a C-shape clip, E-shape clip or a check ring to provide latch function to confine the relative position of the integrated worm gear 10 and the string post 50 and the base 30. Such a structure can prevent the integrated worm gear 10 and the string post 50 from separating from the bore 40 of the base 30, also provide a latch force to couple with the elastic element 60 to enable the integrated worm gear 10 and the string post 50 to be turned steadily on the base 30. To improve the latch effect, the string post 50 may have an annular groove 80 for holding the latch element 70 so that the integrated worm gear 10 and the string post 50 may be confined while the latch element 70 may be held securely without loosening off. The upper side and lower peripheral sides of the bore 40 also may have respectively an annular holding surface 90 and 91 for holding the elastic element 60 and the latch element 70 to improve the entire fitness and coupling quality.

Refer to FIG. 4 for an embodiment of the invention adopted on a guitar. Each base 30 has three sets of guitar machine head string lock function. Hence one guitar needs two sets of base 30 that includes six sets of guitar machine head string lock function to adjust the tension of the strings 96. Each of the strings 96 has one end fastened to a saddle 96 and other end winding on the string post 50. A tuning peg 97 may be used to adjust the tension of the string 96 as desired. According to the invention, there is no screw fastening. Assembly is simpler and convenient. There is no concern of screw loosening. As the worm gear 10 and the string post 50 are integrated, hence there are also no problems of circular coupling deviation and assembly tolerance. The assembly is more precise and users can adjust the string tension steadily. It offers significant improvements over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A guitar machine head string lock function for adjusting string tension of a guitar through a worm gear and a worm that engage with each other, comprising:
a base having a bore smaller than the worm gear;
a string post integrally formed with the worm gear being coupled with the bore; and
a latch element having an outer diameter larger than the bore and being coupled on an outer side of the string post to latch the string post on the base in a pivotal manner.

2. The guitar machine head string lock function of claim 1, wherein the string post has a groove to hold the latch element to pivotally couple the string post on the base.

3. The guitar machine head string lock function of claim 1, wherein the base has an annular holding surface formed around the bore on a contact side with the latch element.

4. The guitar machine head string lock function of claim 1, wherein the latch element is a C-shape clip.

5. The guitar machine head string lock function of claim 1, wherein the latch element is an E-shape clip.

6. The guitar machine head string lock function of claim 1, wherein the latch element is a check ring.

7. The guitar machine head string lock function of claim 1 further having an elastic element which has an outer diameter larger than the bore and is coupled on an outer side of the string post between the base and the worm gear.

8. The guitar machine head string lock function of claim 7, wherein the elastic element is a undulate spring reed.

9. The guitar machine head string lock function of claim 7, wherein the base has an annular holding surface formed around the bore on a contact side with the elastic element.
